(19) United States
(12) Patent Application Publication
(10) Pub. No.: US 2014/0117008 A1
(43) Pub. Date: May 1, 2014

(54) Pressure Vessel

(71) Applicant: MIKROWELLEN-LABOR-SYSTEME GMBH, Leutkirch (DE)

(72) Inventors: Werner LAUTENSCHLAEGER, Leutkirch (DE); Jens LAUTENSCHLAEGER, Heerbrugg (CH)

(73) Assignee: MIKROWELLEN-LABOR-SYSTEME GMBH, Leutkirch (DE)

(21) Appl. No.: 13/665,078

(22) Filed: Oct. 31, 2012

(51) Int. Cl. H05B 6/64

(52) U.S. Cl. CPC H05B 6/6402
USPC 219/756

(57) ABSTRACT

A pressure vessel for receiving samples to be heated is provided, the pressure vessel has a closable reaction chamber as a pressure chamber for initiating and/or promoting chemical and/or physical pressure reactions, and the pressure vessel has a microwave-permeable region, by way of which microwaves can be coupled into the reaction chamber. A hollow light guide pipe extends from the microwave-permeable region towards an infrared sensor, which is arranged outside the pressure chamber, and by way of which the infrared radiation emitted by the heated samples in the reaction chamber is guided during a pressure reaction to the infrared sensor. In the microwave-permeable region, an infrared-permeable pressure receiving part is provided, between the reaction chamber and the light guide pipe and lies against the reaction chamber, in order to support the light guide pipe in the microwave-permeable region.

The present invention relates to a pressure vessel for receiving samples to be heated and to a method for measuring the temperature of samples to be heated that have been received in a pressure vessel.

A device and a method for measuring the temperature of samples to be heated, in particular samples heated by means of microwaves, is known from DE 44 12 887 A1. The device shown therein has a closed, infrared-permeable pressure vessel. Positioned directly in front of the pressure vessel, in its upper region, that is to say above the surface of the pressure vessel, is a quartz light guide, the other end of which is located directly in front of a selective, narrow-band infrared detector.

DE 42 00 462 A1 shows a device for measuring the heating temperature in an intense electrical field of microwaves. A fibre-optic cable is provided for the transmission of infrared radiation from a microwave chamber.

It is thus an object of the invention to make available a pressure vessel and a temperature measuring method of the kind mentioned at the beginning, with which a secure, simple, compact temperature measurement that is temperature- and pressure-resistant in a wide range and precise is made available.

According to a first aspect of the invention, a pressure vessel for receiving samples to be heated is provided, the pressure vessel having a (preferably optionally) closable reaction chamber as a pressure chamber for initiating and/or promoting chemical and/or physical pressure reactions, and the pressure vessel having a microwave-permeable region, by way of which microwaves can be coupled into the reaction chamber. A hollow light guide pipe extends from the microwave-permeable region to an infrared sensor, which is arranged outside the pressure chamber, and by way of which the infrared radiation emitted by the heated samples in the reaction chamber is guided during a pressure reaction to the infrared sensor. In the microwave-permeable region, an infrared-permeable pressure receiving part is provided, between the reaction chamber and the light guide pipe and preferably lying against the reaction chamber, in order to support the light guide pipe in the microwave-permeable region.

According to an alternative embodiment, a pressure vessel for receiving samples to be heated is provided, the pressure vessel having a (preferably optionally) closable reaction chamber as a pressure chamber for initiating and/or promoting chemical and/or physical pressure reactions, and the pressure vessel having a pressure vessel wall enclosing the reaction chamber. A hollow light guide pipe extends from the pressure vessel wall to an infrared sensor, which is arranged outside the pressure chamber, and by way of which the infrared radiation emitted by the heated samples in the reaction chamber is guided during a pressure reaction to the infrared sensor. In a part of the pressure vessel wall, an infrared-permeable pressure receiving part is provided, between the reaction chamber and the light guide pipe and preferably lying against the reaction chamber, in order to support the light guide pipe in the part of the pressure vessel wall. The samples are preferably heated by means of microwaves or a thermal immersion heater.

In this way it is possible to carry out temperature checks by means of an infrared sensor in a great pressure range (for example from 5 bar to 400 bar), the infrared radiation emitted by the heated samples being guided securely, quickly, simply and compactly by way of a hollow light guide pipe to an infrared sensor. The light guide pipe is in this case securely supported with respect to the surrounding regions of the pressure vessel, in particular also with respect to the pressure chamber or the reaction chamber, by means of an infrared-permeable pressure receiving part. The infrared sensor can consequently focus on a relatively small area of the pressure receiving part (since the light guide pipe is securely supported), and, because of the use of the hollow light guide pipe, at the same time has a very good light yield for the infrared range, which makes excellent contactless measurement possible.

The light guide pipe is preferably filled with gas, particularly preferably with infrared-permeable light-guiding fibres for guiding the infrared radiation, the light-guiding fibres preferably being oriented in the direction of a longitudinal extent of the light guide pipe. It is consequently possible, in particular by the use of light-guiding fibres, to improve the infrared radiation transmission by internal reflection.

The light guide pipe is preferably provided with a thermal sensor outside the pressure chamber, preferably outside the microwave-permeable region or (the part of) the pressure vessel wall. In this way, a simple check on the heating in the HF-(MW) range (high-frequency microwave range) can be provided.

The infrared sensor preferably has a measuring range of 1-8 μm, that is to say a high permeability for infrared radiation in the aforementioned range.

The pressure receiving part is preferably made of aluminum oxide, sapphire, calcium fluoride, quartz or ceramic. In this way, a pressure receiving part that is temperature-resistant, hard (scratch-resistant), resistant to chemicals and has good light-guiding properties is made available.

The pressure receiving part preferably has a transmission window for infrared radiation in a predetermined wavelength range, for example from 2500 waves per cm to 3500 waves per cm, infrared radiation outside this transmission window being absorbed to a great extent. In this way, the pressure receiving part serves as a filter for a predetermined wavelength range, which for example corresponds to the receivable range of the infrared sensor.

The pressure vessel preferably has a lower part and a cover part, which can be closed with respect to each other and in the closed state surround the reaction chamber on all sides. In this way, an easily accessible and simple to handle pressure vessel is provided.

The cover part preferably has a mechanical support or magnetic mounting for receiving a sample receiving part and/or a vessel insert and/or a stirrer. The fastening of the aforementioned parts can consequently be simplified, and therefore the implementation of the analysis process can be shortened overall.

The pressure vessel preferably also has a motor, by means of which the sample receiving part and/or the vessel insert and/or the stirrer and/or the magnets of the magnetic mounting and/or magnets arranged underneath the sample receptacle or the vessel insert can be rotatably driven. In this way, even heating, and consequently a more precise sample reaction, can be achieved. Moreover, the duration of the reaction is shortened, with an improved result.

The pressure vessel preferably has an insulating lining, which encloses the reaction chamber and particularly preferably is made of plastic, PTFE or ceramic. The insulating lining serves as an insulator of the pressure vessel with respect to a heated sample. Apart from reducing the thermal loading, the insulating lining also serves as corrosion protection for the inner wall of the pressure vessel and as protection for the inner wall of the pressure vessel from chemical loading by the sample.

The pressure vessel preferably has a cooling arrangement, surrounding the reaction chamber (at least partially), in such a way that the pressure vessel is simultaneously heatable and coolable, the cooling arrangement preferably being a through-flow cooling arrangement and having at least one inlet and one outlet for a cooling medium. In this way, thermal influencing of the pressure vessel can be reduced or even avoided.

According to a second aspect of the invention, a method for measuring the temperature of samples to be heated that have been received in a pressure vessel is provided. The method has the following steps: heating the samples in a (preferably optionally) closable reaction chamber of the pressure vessel to initiate and/or promote chemical and/or physical pressure reactions, the heating taking place by means of microwaves which are coupled into the reaction chamber by way of a microwave-permeable region of the pressure vessel, and guiding the infrared radiation emitted by the heated samples in the reaction chamber during a pressure reaction by way of a hollow light guide pipe to an infrared sensor arranged outside the pressure chamber, the hollow light guide pipe extending from the microwave-permeable region to the infrared sensor, the light guide pipe being supported in the microwave-permeable region by way of an infrared-permeable pressure receiving part, which is provided in the microwave-permeable region between the reaction chamber and the light guide pipe and preferably lies against the reaction chamber.

According to an alternative embodiment, a method for measuring the temperature of samples to be heated that have been received in a pressure vessel is provided. The method has the following steps: heating the samples in a (preferably optionally) closable reaction chamber of the pressure vessel to initiate and/or promote chemical and/or physical pressure reactions, the heating taking place by means of a thermal immersion heater, which protrudes into the reaction chamber as far as the region of the sample reception, and guiding the infrared radiation emitted by the heated samples in the reaction chamber during a pressure reaction by way of a hollow light guide pipe to an infrared sensor arranged outside the pressure chamber, the hollow light guide pipe extending from the pressure vessel wall surrounding the reaction chamber to the infrared sensor, the light guide pipe being supported in the pressure vessel wall by way of an infrared-permeable pressure receiving part, which is provided in a part of the pressure vessel wall between the reaction chamber and the light guide pipe and preferably lies against the reaction chamber.

The pressure vessel, which preferably has an insulating lining enclosing the reaction chamber, is preferably heated by the samples that are heated by means of microwave heating or a thermal immersion heater and simultaneously cooled by a cooling arrangement surrounding the reaction chamber.

The light guide pipe is preferably filled with gas, particularly preferably with infrared-permeable light-guiding fibres, by way of which the infrared radiation is guided. In this way, the infrared radiation transmission can be further improved by internal reflection.

Further configurations and advantages of the invention are described below on the basis of exemplary embodiments in conjunction with the figures of the accompanying drawings.

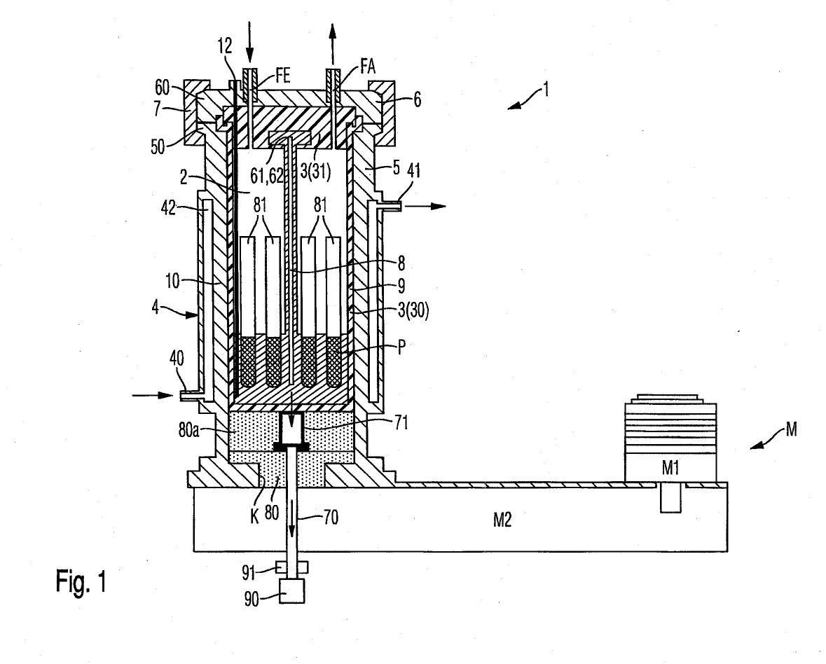

FIG. 1 shows a first embodiment of a pressure vessel according to the invention,

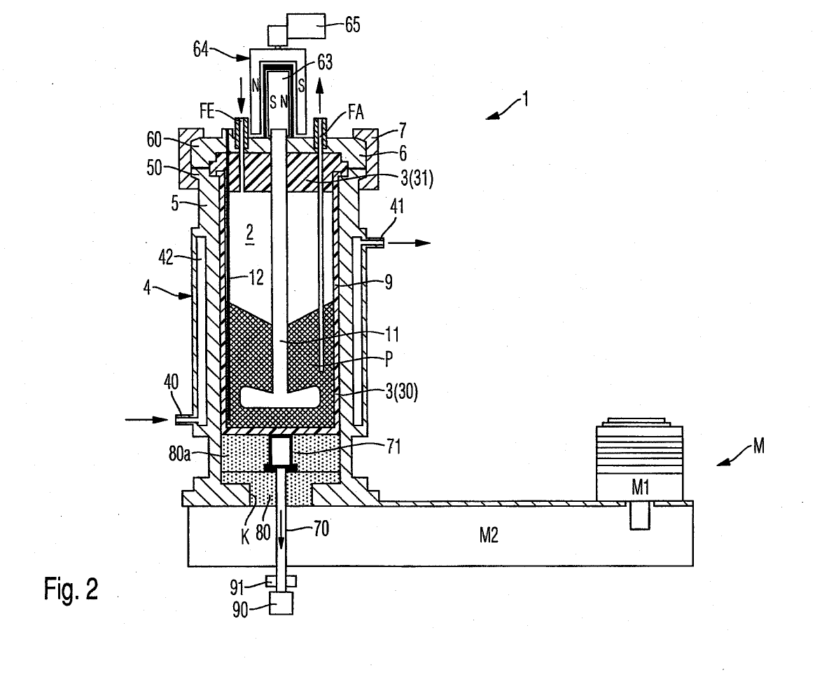

FIG. 2 shows a second embodiment of a pressure vessel according to the invention.

FIGS. 1 and 2 show a first and a second embodiment of a pressure vessel 1 according to the invention (hereafter also referred to as the “vessel” or “sample container”) for receiving samples P to be heated to initiate and/or promote chemical and/or physical pressure reactions on the samples P. The pressure vessel 1 preferably has a high-pressure-resistant material, such as for example metal, preferably steel, particularly preferably a special metal alloy. The pressure vessel 1 is in this case preferably formed in such a way that it can be used at pressures of up to at least 200 bar, preferably up to at least 500 bar, and at temperatures of over 300° C.

The pressure vessel 1 surrounds a reaction chamber or a pressure chamber 2 for initiating and/or promoting the chemical and/or physical pressure reactions on the samples P. The sample P is arranged for sample treatment in the reaction chamber 2 and can be removed from it, preferably through an opening. The reaction chamber 2 is consequently preferably optionally closable.

The pressure vessel 1 also preferably has an insulating lining 3 enclosing the reaction chamber 2 (known as a liner). This insulating lining 3 preferably is made of plastic, PTFE, ceramic or tantalum. The insulating lining 3 consequently serves on the one hand as an insulator of the pressure vessel 1 with respect to the heated sample P and on the other hand, apart from reducing the thermal loading, as corrosion protection for the inner wall of the pressure vessel and as protection for the inner wall of the pressure vessel from chemical loading by the sample P. The insulating lining 3 has for example a wall thickness of 3 to 10 mm, preferably 4 to 6 mm.

Furthermore, the pressure vessel 1 preferably has a cooling arrangement 4, which is arranged in such a way that it surrounds the reaction chamber 2 at least partially, preferably completely, and the cooling channel consequently forms a cooling shell 42. The cooling arrangement 4 preferably surrounds at least the region of the sample reception of the pressure vessel 1. The region of the sample reception is in this case the region in the reaction chamber 2 in which the sample P is located for the sample reaction; here, and as also in the case of the embodiments shown, it is in particular the lower region of the reaction chamber 2. The cooling arrangement 4 preferably surrounds the side walls 10 of the pressure vessel 1 over its entire length, particularly preferably the cooling arrangement 4 surrounds the entire pressure vessel 1, in particular the regions at which the insulating lining 3 is arranged. In this way, the pressure vessel 1, which during the sample reaction is heated from the inside by means of the heated sample P, is simultaneously cooled, so that the thermal loading of the pressure vessel 1 can be correspondingly regulated, and for example kept below a predetermined temperature. For example, when an insulating lining 3 that is only 5 mm thick, or thin, is used, a temperature gradient of the insulating lining 3 in relation to room temperature of 300° C. can be achieved in a simple manner. In this way, the pressure vessel 1 can be cooled by the cooling arrangement 4 in such a way that the temperature at the transition between the inner wall of the pressure vessel and the insulating lining 3 is kept at room temperature or a temperature that is predetermined as desired by the user. If the temperature of the pressure vessel 1 is so low in comparison with the sample chamber or the reaction chamber 2, that is to say for example below 100° C., preferably room temperature or below, corrosion of the pressure vessel 1, for example because of acid molecules or the like diffusing out from the reaction chamber 2 through the insulating lining 3, is also avoided. As a result, the lifetime of the pressure vessel 1 is prolonged significantly in comparison with a pressure vessel that is cooled only unevenly or not at all. In this way, absolutely identical conditions within the reaction chamber 2 can also be achieved, which in turn leads to quicker and more precise sample treatment. The identical conditions in the reaction, chamber 2 allow all analysis processes to be permanently subjected to analytical quality monitoring, for example by the use of internal reference standards, and then for example issued with a certificate.

Because of the insulating lining 3, the heated sample P and the high wave density produced by the microwaves, for example at 1500 W, only heat said pressure vessel 1 with a delay, and/or in a diminished form, in comparison with an arrangement without an insulating lining, so that the pressure vessels 1 are only exposed to comparatively small thermal influences or differences.

This is positively influenced further by the fact that the pressure vessel 1 has, at least in the region of the sample reception of the pressure vessel 1, preferably over the entire region of the side walls of the pressure vessel 1, the cooling arrangement 4 surrounding it, which simultaneously cools the pressure vessel 1 in particular in the region of the greatest heating, and thereby counteracts the thermal influences on the pressure vessel 1 of the sample P and of the heating. In this way, thermal influencing of the pressure vessel 1 can be reduced or even avoided. In particular, the pressure vessel 1 is cooled in such a way that it does not exceed a predetermined temperature threshold value. For this purpose, the cooling may begin or be switched off again when a specific temperature of the pressure vessel 1 is reached, or the pressure vessel wall is preferably already cooled from the beginning of the heating operation and/or permanently cooled. In the case of permanent cooling from the beginning of the heating operation, it is possible to avoid the temperature of the pressure vessel wall exceeding a certain value, for example room temperature, from an early time. It is also conceivable for the cooling only to commence later or to be switched off already before the completion of the sample reaction. Preferably, however, the cooling is already begun before or at least from the beginning of the heating operation and also continued after completion of the heating operation. Prompt commencement of the cooling from the beginning and cooling permanently during the course of the test also have the effect of considerably reducing wear of the pressure vessel 1. The further cooling after completion of the heating operation has the effect that the temperature difference or temperature gradient between the reaction chamber 2 and the pressure vessel 1 is reduced (abruptly), so that particularly quick cooling of the sample P is made possible in spite of the insulating lining 3, while the pressure vessel wall continues to be kept at a constantly low level. Consequently, because of consistently low temperatures, corrosion of the pressure vessel 1 is avoided, even during and after the heating operation, and its lifetime prolonged considerably.

The direct heating of the sample P consequently allows extremely quick heating rates to be achieved. The simultaneous cooling, preferably permanently and from the beginning, has the effect on the one hand of reducing the thermal loading of the pressure vessel 1, and on the other hand of simultaneously allowing quicker cooling of the sample P to be achieved after a sample reaction has been carried out.

The cooling arrangement 4 preferably has at least one fluid inlet 40 and one fluid outlet 41 for a cooling medium, so that it is formed as a through-flow cooling arrangement or pumparound cooler or circulating cooler. Used as the coolant is a fluid, preferably air, or a liquid coolant. If the temperature of the pressure vessel 1 is intended to be kept below 100° C., preferably at room temperature, water, which is particularly easily available and inexpensive, may be used for example as the cooling medium. Moreover, any other known cooling medium that has a higher (or lower) boiling point and/or a higher (or lower) thermal gradient than water may also be used. The cooling medium is for example passed through the pumparound cooler 4 outside the pressure vessel 1 by means of a pump arrangement (not shown) and is cooled by means of a cooling element (not shown), such as for example a heat exchanger. The cooling arrangement 4 may for example also be formed as a (run-through) cryostat, the cooling medium being introduced into the system at very low temperatures in order, because of the great temperature difference, to achieve cooling of the pressure vessel 1 with respect to the reaction chamber 2, which has for example been heated to 300° C., for example to room temperature. For example, when microwave heating is used, corresponding cooling and preservation of the pressure vessel 1 can be achieved in spite of the high wave density in the reaction chamber 2 in comparison with classic autoclaves. In particular, the pressure vessel 1 is preserved in such a way that for example corrosion caused by substances diffusing through out of the reaction chamber 2 is avoided.

The pressure vessel 1 preferably has a (pot-shaped) lower part 5 and a cover part 6 (hereafter also referred to as the “cover”), which can be closed with respect to each other and in the closed state surround the reaction chamber 2 on all sides. In this case, the cover 6 closes the opening provided in the pressure vessel 1, that is to say the lower part 5 of the pressure vessel 1, for introducing and removing the sample P. However, the invention is not restricted to the aforementioned form. At least the lower part 5 has the insulating lining 3, 30; preferably, the cover 6 also has the insulating lining 3, 31.

As can be seen from FIGS. 1 and 2, both the lower part 5 and the cover 6 preferably have corresponding flange regions 50, 60. By means of holding means 7, such as for example clamps, which are arranged around the flange regions 50, 60, the lower part 5 and the cover 6 are pressed against each other in such a way that the pressure vessel 1 surrounds, that is to say forms, the securely closed, pressure-resistant reaction chamber 2. Examples of such holding means 7 are described in more detail in DE 10 2010 030 287.

In a particularly preferred embodiment, the cover 6 is prestressed with respect to the lower part 5, preferably spring-biased, that is to say closed with the aid of a spring force, in order to form the closed reaction chamber 2. The (spring) biasing is in this case formed in such a way that the cover 6 and the lower part 5 move relatively away from each other, counter to the spring biasing, when a predetermined internal pressure is reached within the reaction chamber 2. In this way, the predetermined internal pressure cannot be exceeded because something known as blowing off occurs, i.e. the prestressed cover 6 lifts off (slightly) because of a high internal pressure. This avoids excessive internal pressure, which could lead to the pressure vessel 1 being damaged. Furthermore, in this way predetermined reaction conditions are provided by predetermined pressure conditions in the reaction chamber 2.

In a particularly preferred embodiment, a seal (not shown), which securely seals off the reaction chamber 2 from the outside in the closed, that is to say (spring) biased, state of the pressure vessel 1, is provided between the cover 6 and the lower part 5, preferably between the cover 6 and the insulating lining 3, 30 of the lower part 5. By means of the seal, possible unevennesses, particularly in the flange regions 50, 60, are evened out and a securely closed reaction region is achieved in the reaction chamber 2. The seal is in this case preferably formed as an O-ring. The seal is also preferably securely arranged and held in a correspondingly provided groove in the cover 6 or pressure vessel 1, that is to say the lower part 5, or the insulating lining 3. Furthermore, the seal may preferably also be held by the wall surrounding it of the cover 6 or of the lower part 5. The seal is preferably produced from PTFE.

In a preferred embodiment, the insulating lining 3 has a vessel insert 9 that can be inserted into the pressure vessel 1 (also referred to hereafter as the “PTFE insert”). The vessel insert 9 may be arranged on the cover 6; it is preferably connected to the cover 6 in a removable way. This simplifies handling of the samples P significantly. The vessel insert 9 or the reaction chamber 2 preferably has a capacity of 0.5 to 1 litre; however, the invention is not restricted to this.

Particularly preferably, the samples P can be moved together with the cover 6 in relation to the lower part 5. In this way, after the reaction, the samples P can be removed together with the cover 6 from the pressure vessel 1, to be more specific the lower part 5, or inserted into the pressure vessel 1 for the sample reaction. This preferably takes place by automatic moving in and out. In this way, simple insertion and simple removal of the samples P from the pressure vessel 1 is made possible, thereby dispensing with the onerous and laborious closing of individual pressure vessels 1, which leads to a saving in terms of the sample treatment. For example, it is conceivable for the samples P to be introduced directly into the vessel insert 9. Whenever the vessel insert 9 is detachably connected to the cover 6, the sample P can be simply moved out of the pressure vessel 1 with the cover 6 and moved back again into it. It is for example also possible, however, for a number of samples P to be arranged in a sample receiving part 8 (or a sample cartridge holder according to FIG. 1). For simplified handling of the individual samples P, this sample receiving part 8 may be attached to the cover 6, preferably detachably connected to it, as still to be explained in more detail below. In this way, the treatment time for a sample P is reduced and the laborious closing of each individual pressure vessel 1 or each individual sample P is avoided. For example, the sample receiving part 8 and the vessel insert 9 may also be connected to the cover, for example detachably connected.

In order to connect the sample receiving part 8 and the vessel insert 9 detachably to the cover 6, the cover part 6 may have a mechanical support 61 (cf. FIG. 1) or magnetic mounting 62, 63 (cf. FIGS. 1 and 2). A mechanical mounting 61 may be provided for example by means of a dovetail-shaped mounting or a bayonet connection, the underside of the cover 6 being provided with a corresponding part of the connection, with which a matching part of the connection of the parts to be detachably connected can be connected in a simple manner. As FIG. 1 shows, a sample cartridge holder 8 may for example be inserted into the mechanical support 61 provided in the cover 6, and thereby mounted. As an alternative to this mechanical support 61, a magnetic mounting 62, 63 may also be provided. In other words, magnets (not explicitly shown in FIG. 1; 64 in FIG. 2), which for example mount the sample cartridge holder 8 depicted or a stirrer 11 shown in FIG. 2, may be provided in the upper part 6 of the vessel. However, the invention is not restricted to the types of connection described above. Other types of connection, such as for example screw connections or plug-in connections or snap-in connections and the like, are also covered by the invention.

If the magnets 64 provided in the upper part 6 can be rotatably driven by a motor 65, it is then also possible for example for the stirrer 11 shown in FIG. 2 to be magnetically driven, which is of advantage in particular in the case of the use of a microwave-based sample analysis.

The pressure vessel 1 may consequently have a motor 65, by means of which for example the magnets 64 of the magnetic mounting 63 can be rotatably driven. It is then also possible to arrange the stirrer 11 in the magnetic, rotatably driven mounting 63, and this can then be driven by the magnetic mounting 63 (cf. FIG. 2). However, it is then also possible by means of the motor 65 to rotatably drive for example the sample receiving part 8 and/or the vessel insert 9 and/or the stirrer 11 (all three for example by way of driving the mechanical support 61) and/or the mechanical support 61 and/or the magnets 64 of the magnetic mounting 63 (and by way of these two consequently also the parts arranged (detachably) on them) and/or magnets arranged underneath the sample receptacle, the sample receiving part 8 or the vessel insert 9. In the last-mentioned case, magnetic stirring rods (not shown), preferably arranged in at least one, more than one or all the sample containers 81 of the sample receiving part 8 (sample cartridge holder) or in the reaction chamber 2 itself, are driven by means of the rotatably driven magnets, and can consequently thoroughly stir or mix the sample(s).

According to the embodiment, the lower part 5 and the cover part 6 are movable in relation to each other in an automated manner between an open access position and a closed (microwave) treatment position, a sample receiving part 8 and/or a vessel insert 9 being connected to the cover part 6. In the operating state, the cover part 6 is consequently lowered, preferably automatically, i.e. activated by a control unit and a motor; particularly preferably, a permeable protective hood (not shown) is lowered at the same time with the cover part 6.

According to FIGS. 1 and 2, the samples P are heated by the action of microwaves. In this case, the reaction chamber 2 is at least partially microwave-permeable; the pressure vessel 1 is preferably microwave-impermeable. The microwave-impermeable pressure vessel 1 can be connected to a microwave generator M by way of a microwave-permeable coupling opening K. The coupling opening K, in which or under which a waveguide M2 in connection with a magnetron M1 (and possibly having an associated emitting element, such as an antenna) are arranged, is provided in the bottom of the pressure vessel 1, for example for the coupling in of the microwaves. The introduction of the microwaves consequently preferably takes place through the bottom part of the pressure vessel 1 in a tubular metal reactor. Consequently, a microwave-permeable region 80 of the pressure vessel 1 or of the pressure vessel wall (that is to say in this part of the pressure vessel wall), by way of which the microwaves are coupled into the reaction chamber 2, is formed by the coupling opening K.

The pressure vessel 1 may also have a fluid inlet FE and a fluid outlet FA in the reaction chamber 2, the inlet FE and the outlet FA preferably being arranged in the cover 6. In this case, the inlet FE and the outlet FA may form what is known as a gas flushing device (not shown) for flushing out a gas located in the reaction chamber 2. In another, optional or additional configuration, the inlet FE serves for producing an internal pressure in the reaction chamber 2. A pre-charging pressure with gas may have the effect for example that, already at the beginning of the pressure reaction, the vessel insert 9 is forced against the vessel wall of the pressure vessel 1 for optimum cooling by means of the cooling arrangement 4. The outlet FA on the other hand serves for blowing off an internal pressure in the reaction chamber 2 that exceeds a specific threshold value and generally for reducing pressure. Preferably provided for this purpose in the outlet FA is a valve, which opens when there is corresponding excess pressure, in order to prevent the device from being damaged. The inlet FE and the outlet FA are preferably connected to lines for supplying or removing a gas or for producing an internal pressure in the pressure vessel 1. The line that is connected to the outlet FA preferably has a greater diameter than the line that is connected to the inlet FE, since the line of the outlet FA must withstand the high internal pressure and the high temperatures in the case of a blow-off. If the previously described inlet FE and outlet FA are intended for blowing off, either the previously described seal may be provided in such a way that, when blowing-off occurs by the cover 6 being lifted off counter to the prestressing, the seal exposes a blowing-off gap between the cover 6 and the lower part 5 or the insulating lining 3, 30. Alternatively, the seal may also be provided in such a way that, when the cover 6 lifts off, it ruptures, and consequently the internal pressure in the pressure vessel 1 can drop abruptly, for example if a pressure relief by means of the valve provided in the line of the outlet FA can no longer be enabled with certainty. In this case, a suction extraction device is preferably provided, in order to ensure that gases that are possibly released are extracted.

As shown in FIGS. 1 and 2, the device also has a temperature sensor or a reference temperature sensor 12. This is made for example of tantalum. The temperature sensor is preferably arranged or attached on the cover part 6 in such a way that it protrudes into the sample chamber (reaction chamber, sample container, pressure chamber) when the latter is closed. However, other configurations known to a person skilled in the art for measuring the temperature in the sample chamber are also possible.

As can also be seen in FIGS. 1 and 2, according to the invention the pressure vessel 1 has a device for measuring the temperature of samples P to be heated that have been received in a pressure vessel. For this purpose, the pressure vessel 1 has a hollow light guide pipe 70, which extends from the microwave-permeable region 80 to an infrared sensor 90 arranged outside the pressure chamber. The light guide pipe 70 is for example a pipe, preferably a metal pipe, which is provided in the microwave-permeable region 80, or a bore provided in the microwave-permeable region 80, it being possible for the inner wall of said bore to be coated with a reflective layer or the like.

By way of this light guide pipe 70, the infrared radiation emitted by the heated samples P in the reaction chamber 2 is guided during a pressure reaction to the infrared sensor 90. The intensity of the infrared radiation is in this case a measure of the sample temperature. The light guide pipe 70 is preferably filled with gas, such as for example air, for guiding the infrared radiation. Particularly preferably, the light guide pipe 70 is filled with infrared-permeable light-guiding fibres for guiding the infrared radiation. The light-guiding fibres are then preferably oriented in the direction of a longitudinal extent of the light guide pipe 70. In other words, the light-guiding fibres extend between the microwave-permeable region 80 and the infrared sensor 90 arranged outside the pressure chamber. In this way, the infrared radiation transmission can be further improved by internal reflection, and consequently the measuring precision can be increased. Fibre material with a high infrared transparency is preferably used for the light-guiding fibres.

The infrared sensor 90 is located at an end of the light guide pipe opposite from the reaction chamber 2, preferably outside the microwave-permeable region 80. The infrared sensor 90 preferably has a measuring range, that is to say a permeability for infrared radiation, of 1-8 μm.

Also provided in the microwave-permeable region 80 between the reaction chamber 2 and the light guide pipe 70 is an infrared-permeable pressure receiving part 71, in order to support the light guide pipe 70 in the microwave-permeable region 80. For this purpose, the pressure receiving part 71 is preferably enclosed by a part 80a of the microwave-permeable region 80. The pressure receiving part 71 preferably lies with one of its ends against the reaction chamber 2 or the vessel insert 9. Particularly preferably, the pressure receiving part 71 also lies with its end that is opposite from the aforementioned end against the light guide pipe 70. The light guide pipe 70 then consequently extends out of the microwave-permeable region 80 and from the aforementioned opposite end of the pressure receiving part 71 away from the pressure receiving part 71 and towards the infrared sensor 90.

The pressure receiving part 71 is made of a pressure-resistant material, preferably from aluminium oxide, sapphire, calcium fluoride, quartz, ceramic or other known materials. Particularly preferably, the materials of the pressure receiving part 71 are also temperature-resistant, at least within the temperature range of the sample P during the pressure reaction. Furthermore, they are particularly hard (scratch-resistant) and resistant to the chemicals used. The pressure receiving part 71 is preferably of a cylindrical or cuboidal form or is of some other form.

The invention consequently describes a temperature measurement by way of a light guide (light guide pipe) 70 and a pressure adapter (pressure receiving part) 71. The infrared sensor 90 in this case senses the infrared radiation that is emitted by the heated samples P and guided through the reaction chamber wall, the infrared-permeable pressure receiving part 71 and by way of the hollow light guide pipe 70 (preferably filled with light-guiding fibres). This radiation can then be intensified, for example by way of an electronic amplifier not depicted, and fed to a electronic conversion unit, which converts the electrical signals of the amplifier into digital signals and feeds them to a read-out unit (for example a computer) and/or a control unit. On the basis of the results obtained, the pressure reaction can be controlled, it being possible for example for the magnetron M1 for coupling in microwaves, the cooling device 4 for cooling, stirring or rotating devices or the gas supply into and/or gas removal out of the system to be controlled.

In a preferred embodiment, the pressure receiving part 71 has a transmission window for infrared radiation in a predetermined wavelength range. For a pressure receiving part 71 of quartz, for example, this may lie between 2500 waves per cm and 3500 waves per cm. Infrared radiation outside this transmission window is absorbed to a great extent. The pressure receiving part 71 consequently serves as a filter for the predetermined wavelength range, which cuts out undesired radiation.

The pressure vessel may also be provided with a thermal sensor 91 outside the microwave-permeable region 80. This sensor serves for keeping a check on the heating in the HF-(MW) range.

While in the above exemplary embodiments heating by microwaves by means of a microwave generator M is described in depth, the invention is not restricted to such heating. For example, instead of the microwave generator M, the samples P may also be heated directly by a thermal immersion heater (not shown) or other heating devices. In this case, the immersion heater may be provided directly on the cover 6, the immersion heater being formed in such a way that it protrudes into the reaction chamber 2 as far as the region of the sample reception, at least during a pressure reaction. If a number of samples P are arranged in individual sample containers 80 and for example a sample receiving part 8 in the pressure vessel 1, that is to say the reaction chamber 2, an immersion heater as described above may also be respectively provided for each sample container 80 or each sample P. Similarly, the electrical connections for the immersion heater, by way of which it can be supplied with power, are preferably provided in the cover 6.

When an immersion heater is used, there is generally no microwave-permeable region in which the pressure receiving part 71 and the light guide pipe are arranged. In this case, the pressure receiving part 71 is provided in the pressure vessel wall, to be more specific a part of the pressure vessel wall, and preferably also lying against the reaction chamber 2, from which the light guide pipe 70 extends away from the sample chamber towards the infrared sensor 90.

The only difference between the two heating methods described above is consequently an optional changeover of the heating devices (for example microwave generator M and immersion heater, including the specifically associated features such as a microwave-permeable region, electrical connections for the immersion heater and the like). Therefore, with respect to the heating by means of an immersion heater, reference is made to the description of the exemplary embodiments of FIGS. 1 and 2 in full, which apart from heating by means of microwaves is also applicable in the same way in the case of other heating methods.

According to a method for initiating and/or promoting chemical and/or physical pressure reactions on samples P, the samples P are heated in a reaction chamber 2, which can be heated by means of heating (preferably by microwaves or else by means of a thermal immersion heater and the like), of a pressure vessel 1 surrounding the reaction chamber 2 on all sides and preferably having the lower part 5 and the cover part 6, and thereby exposed to a pressure. The sample receiving part 8 and/or the vessel insert 9 may in this case be inserted into the reaction chamber 2 or preferably connected to the cover part 6. The samples P are preferably heated while stirring (for example by way of a motor driving the sample cartridge holder 8 or a stirrer 11 driven by means of magnets).

According to a method according to the invention for measuring the temperature of samples P to be heated that have been received in a pressure vessel 1, the samples P are first heated, for example in the way described above. This consequently takes place in a preferably optionally closable reaction chamber 2 of the pressure vessel 1 for initiating and/or promoting chemical and/or physical pressure reactions. The heating preferably takes place by means of microwaves, which are coupled into the reaction chamber 2 by way of a microwave-permeable region 80 of the pressure vessel 1. Heating by means of an immersion heater and the like, which protrudes into the reaction chamber 2 or the sample container 81 as far as the region of the sample reception, is also conceivable. The infrared radiation emitted by the heated samples P in the reaction chamber 2 is guided during the pressure reaction by way of a hollow light guide pipe 70 to an infrared sensor 90 arranged outside the pressure chamber, the hollow light guide pipe 70 extending from the microwave-permeable region 80 to the infrared sensor 90 or extending from the pressure vessel wall surrounding the reaction chamber 2 to the infrared sensor 90. The light guide tube 70 is preferably filled with gas or particularly preferably with infrared-permeable light-guiding fibres, by way of which the infrared radiation is guided. The light guide pipe 70 is in this case supported in the microwave-permeable region 80 by way of an infrared-permeable pressure receiving part 71, which is provided in the microwave-permeable region 80 between the reaction chamber 2 and the light guide pipe 70 and preferably lies against the reaction chamber 2. In the case of other heating, such as for example an immersion heater, the light guide pipe 70 is supported in the pressure vessel wall by way of an infrared-permeable pressure receiving part 71, which is provided in a part of the pressure vessel wall between the reaction chamber 2 and the light guide pipe 70 and preferably lies against the reaction chamber 2.

In a preferred embodiment, the pressure vessel 1, which preferably has an insulating lining 3 enclosing the reaction chamber 2, is heated by the samples P that are heated by means of microwave heating or a thermal immersion heater and simultaneously cooled by a cooling arrangement 4 surrounding the reaction chamber 2.

The method steps of all the methods described above can be carried out as desired together with one another.

It should be pointed out that the invention is not restricted to the configurations depicted in the aforementioned exemplary embodiments, as long as variations are covered by the subject matter of the claims. In particular, the pressure vessel is not restricted to the aforementioned pot shape. Similarly, other possibilities for the heating of the sample are conceivable. The cooling arrangement is also not restricted to cooling by a pumparound cooler, as long as the required cooling is achieved. Moreover, the invention is not restricted to a specific material of the inner lining, as long as it achieves the desired insulating effect. All of the features of the aforementioned exemplary embodiments may be combined or occur together in any desired way.

1. A pressure vessel for receiving samples to be heated, the pressure vessel comprising:
a closable reaction chamber configured as a pressure chamber for initiating and/or promoting chemical and/or physical pressure reactions;
a microwave-permeable region, by way of which microwaves can be coupled into the reaction chamber;
a hollow light guide pipe configured to extend from the microwave-permeable region towards an infrared sensor, which is arranged outside the pressure chamber, and by way of which the infrared radiation emitted by the heated samples in the reaction chamber is guided during a pressure reaction to the infrared sensor; and
an infrared-permeable pressure receiving part provided in the microwave-permeable region, between the reaction chamber and the light guide pipe and lying against the reaction chamber, in order to support the light guide pipe in the microwave-permeable region.

2. A pressure vessel for receiving samples to be heated, the pressure vessel comprising:
a closable reaction chamber configured as a pressure chamber for initiating and/or promoting chemical and/or physical pressure reactions;
a pressure vessel wall enclosing the reaction chamber;
a hollow light guide pipe configured to extend from the pressure vessel wall towards an infrared sensor, which is arranged outside the pressure chamber, and by way of which the infrared radiation emitted by the heated samples in the reaction chamber is guided during a pressure reaction to the infrared sensor;
an infrared-permeable pressure receiving part provided in a part of the pressure vessel wall, between the reaction chamber and the light guide pipe and lying against the reaction chamber, in order to support the light guide pipe in the part of the pressure vessel wall.

3. The pressure vessel according to claim 2, wherein the samples are heated by microwaves or a thermal immersion heater.

4. The pressure vessel according to claim 1, wherein the light guide pipe is filled with gas or infrared-permeable light-guiding fibres for guiding the infrared radiation, and wherein the light-guiding fibres are oriented in a direction of a longitudinal extent of the light guide pipe.

5. The pressure vessel according to claim 1, wherein the light guide pipe is provided with a thermal sensor outside the pressure chamber, outside the microwave-permeable region, or the pressure vessel wall, for keeping a check on the heating in the HF-(MW) range.

6. The pressure vessel according to claim 1, wherein the infrared sensor has a measuring range of 1-8 μm.

7. The pressure vessel according to claim 1, wherein the pressure receiving part is made of aluminum oxide, sapphire, calcium fluoride, quartz or ceramic.

8. The pressure vessel according to claim 1, wherein the pressure receiving part has a transmission window for infrared radiation in a predetermined wavelength range, for example from 2500 waves per cm to 3500 waves per cm, infrared radiation outside this transmission window being absorbed to a great extent.

9. The pressure vessel according to claim 1, wherein the pressure vessel has a lower part and a cover part, which can be closed with respect to each other and which in a the closed state surrounds the reaction chamber on all sides, wherein the cover part has a mechanical support or magnetic mounting for receiving a sample receiving part and/or a vessel insert and/or a stirrer, and wherein the pressure vessel has a motor, by means of which the sample receiving part and/or the vessel insert and/or the stirrer and/or the magnets of the magnetic mounting and/or magnets arranged underneath the sample receptacle or the vessel insert are rotatably driven.

10. The pressure vessel according to claim 1, the pressure vessel having an insulating lining, which encloses the reaction chamber and preferably consists of plastic, PTFE or ceramic.

11. The pressure vessel according to claim 1, the pressure vessel having a cooling arrangement, surrounding the reaction chamber, in such a way that the pressure vessel is simultaneously heatable and coolable, the cooling arrangement preferably being a through-flow cooling arrangement and having at least one inlet and one outlet for a cooling medium.

12. A method for measuring a the temperature of samples to be heated that have been received in a pressure vessel, the method comprising:
heating the samples in a closable reaction chamber of the pressure vessel to initiate and/or promote chemical and/or physical pressure reactions, the heating taking place by means of microwaves which are coupled into the reaction chamber by way of a microwave-permeable region of the pressure vessel; and
guiding the infrared radiation emitted by the heated samples in the reaction chamber during a pressure reaction by way of a hollow light guide pipe to an infrared sensor arranged outside the pressure chamber, the hollow light guide pipe extending from the microwave-permeable region towards the infrared sensor,
wherein the light guide pipe is supported in the microwave-permeable region by way of an infrared-permeable pressure receiving part, which is provided in the microwave-permeable region between the reaction chamber and the light guide pipe and lies against the reaction chamber.

13. A method for measuring a temperature of samples to be heated that have been received in a pressure vessel, the method comprising:
heating the samples in a closable reaction chamber of the pressure vessel to initiate and/or promote chemical and/or physical pressure reactions, the heating taking place by means of a thermal immersion heater, which protrudes into the reaction chamber as far as the region of the sample reception; and
guiding the infrared radiation emitted by the heated samples in the reaction chamber during a pressure reaction by way of a hollow light guide pipe to an infrared sensor arranged outside the pressure chamber, the hollow light guide pipe extending from the pressure vessel wall surrounding the reaction chamber towards the infrared sensor,
wherein the light guide pipe is supported in the pressure vessel wall by way of an infrared-permeable pressure receiving part, which is provided in a part of the pressure vessel wall between the reaction chamber and the light guide pipe and lies against the reaction chamber.

14. The method according to claim 12, wherein the pressure vessel, which has an insulating lining enclosing the reaction chamber, is heated by the samples that are heated by means of microwave heating or a thermal immersion heater and simultaneously cooled by a cooling arrangement surrounding the reaction chamber.

15. The method according to claim 12, wherein the light guide pipe is filled with gas or infrared-permeable light-guiding fibres, by way of which the infrared radiation is guided.
